(19) United States
(12) Patent Application Publication
(10) Pub. No.: US 2004/0267419 A1
(43) Pub. Date: Dec. 30, 2004

(54) Electronic circuit system named mobile safety communication (MSC) device embedded in the rearview/side mirror of a vehicle

(76) Inventor: Jack Ing Jeng, Arcadia, CA (US)

Correspondence Address: LAW OFFICES OF J.F. LEE, 17800 CASTLETON STREET, SUITE 383, CITY OF INDUSTRY, CA, 91748, US

(21) Appl. No.: 10/603,460

(22) Filed: Jun. 25, 2003

(51) Int. Cl. G06F 7/00; G01C 21/26

(52) U.S. Cl. 701/36; 701/213; 455/426.2

(57) ABSTRACT

A method of operation and electronic apparatus named Mobile Safety Communication (MSC) for recording the driving data, wireless communication for voice/video/data, anti-theft device, and a GPS (Global Positioning System) unit embedded into a rearview/side mirror or stand-alone unit which is mounted onto the windshield of a vehicle. The MSC measures the vehicle various motions include acceleration, de-acceleration, up/down vibration, and flipped-over condition. A method of operation related to the acceleration/de-acceleration sensor/gauge that identifies the significant instances to the central control of MSC for coordinating the Flash memory storage, digital camera shots and alarm activation; the control or recording of the data is capable of being interfaced or networked to other digital devices such as computers or other peripherals.

### FIELD OF THE INVENTION

This invention relates to the field of mobile safety monitoring and recording of voice/video/motion information and mobile wireless communication domain. In particular, this electronic circuit system comprising of a GPS receiver module, wireless communication module, digital cameras with a compression module, voice/telephone communication module, Smart Card reader and an exclusive acceleration/de-acceleration/vibration sensor/gauge, are all embedded into the rearview/side mirror or a stand-alone unit mounted on the windshield glass of a vehicle. A key component of the present invention is the acceleration/de-acceleration/vibration sensor/gauge.

### BACKGROUND OF THE INVENTION

The GPS (Global Positioning System) receiver device in a vehicle can be very useful in tracking an automobile for the exact geographical position of the automobile in the instance of an emergency, management and security. Truck fleets, commercial vehicles, UPS transport vehicles, police cars and even ordinary cars can be tracked automatically for many purposes such as obtaining driving directions, positioning a vehicle on a map, managing a fleet of commercial vehicles, or in an event of an emergency situation or crime occurrence.

FIG. 1 shows a typical GPS receiver module: 101 indicates the GPS satellites. 102 is the GPS receiver antenna that picks up multiple satellite broadcast signals for its geographical positions. 104 is the Radio receiver and 106 is the GPS processor controller with 108 Serial UART interfaced to the Central Control Host. 110 is a parallel interface to the Central Control Host. The 104 can be a STB5600 Integrated Circuit (IC) from ST Micro-Electronics Inc. and the 106 can be a ST-20-GP6 IC. The driving record of the video/voice recording for an automobile can be retrieve for many purposes: record and replay the instance of an accident, driving violations and crime instances that occur, replay a commercial vehicle's daily operation for supervision and management control, monitor teenagers' driving habits for parents.

The vehicle motion recording is exceptionally useful for analyzing the car's movement during an accident.

The voice communication for the vehicle is designed very carefully so as not to affect the driver's control of a vehicle. Yet voice communication is beneficial especially in the instance of emergency such as earthquake alarm (not warning), tornado alarm (not warning), war breakout or an enemy attack etc. These examples can be broadcasted and override the existing voice communication. This multicast scheme or group voice broadcasting is also functional for truck fleet management and efficiency.

The wireless communication is accessible to the Internet Network, private wireless network or other automobile to communicate information automatically or manually with real-time video, and a GPS position. Voice phone calls, or Internet Communication protocols/data, and especially Internet voice/video/data communication protocols, are all abundant features of roaming, multicast, broadcast, that QOS (Quality Of Service) help to manage and control these transmissions.

There are many ways of mobile wireless communications: CB (Citizen Band) radio, MURS (Multi-User Radio Service), FRS (Family Radio Service), GMRS (General Mobile Radio Service), ISM (Industrial Science and Medical) band. These mobile communications are license-free but are regulated by the FCC (Federal Communication Commissions).

There are also Public wireless communication systems of mobile phone services such as GSM, CDMA, PCS networks that obtain a frequency band from the FCC to serve for voice or data communications.

The I.E.E.E. 802.11 committee develops standards for wireless local area networks (LAN) or WLAN. 802.11 is then further divided: 802.11b, or Wi-Fi, is a standard for wireless LANs operating in the 2.4 GHz spectrum with a bandwidth of 11 Mbps. 802.11a is a different standard for wireless LANs operating in the 5 GHz frequency range with a maximum data rate of 54 Mbps. Another draft standard, 802.11g, is for WLAN, operating in the 2.4 GHz frequency but with a maximum data rate of 54 Mbps. Other task groups are working on enhanced security (802.11i), spectrum and power control management (802.11h), quality of service (802.11e), etc.

CB radios operate in the 27 Mhz frequency range, where small external base station antennas are allowed, and the transmitter power is limited to 4W(AM), or 12W(SSB). As its popularity grew, the FCC responded by increasing the number of available channels from 28 to 40.

The MURS (Multi-User Radio Service) is a private, two-way, short-distance voice or data communications service for personal or business activities of the general public. The MURS is operated in the frequencies of 151.820 MHz, 151.880 MHz, 151.940 MHz, 154.570 MHz and 154.600 MHz and is regulated by FCC but is license free.

The FRS (Family Radio Service) radio is operated on 14 frequencies in the UHF frequency band, in the 462-467 MHz-frequency range, with the transmitter power output limited to 500 mW ERP. The FCC imposed very strict power and antenna limitations on the manufacturers of FRS radios. Unfortunately, these limitations leave FRS radios with rather weak communications ranges.

The Industrial, Scientific and Medical (ISM) radio bands were originally reserved internationally for non-commercial use of RF electromagnetic fields for industrial, scientific and medical purposes. The ISM bands are defined by the ITU-T in S5.138 and S5.150 of the Radio Regulations. Individual countries' use of the bands designated in these sections may differ due to modifications in national radio regulations. In recent years they have also been used for license-free error-tolerant communications applications such as wireless LANs and Bluetooth. The ISM frequency are: 900 MHz band (33.3 cm) and 2.45 GHz band (12.2 cm). IEEE 802.11 wireless ethernet also operates on the 2.45 Ghz band

Sooner or later, public phone booths, gas stations, fast food restaurants with drive through lanes and shopping malls will be equipped with WI-FI/802.1×. 802.11 Hot Point/Access Point will also be set up so that notebooks, PCs, PDAs or vehicles equipped with WI-FI Mobile Unit devices, can be connected to Internet Networks or Private Networks.

The Ethernet is the most widely used in Local Area Network (LAN) technology. The 10/100 Base Ethernet defined by I.E.E.E 802.3 is operating up to 100 Mbps baud rate via a 2-pair Cat-5 UTP (Un-shield Twisted Pair) cable.

FIG. 2 shows a typical wireless communication for a car. In this case, a 802.11b/e wireless communication block diagram is shown. 111 is the transmitter and receiver antenna. The 114 is a RF filter and 116 is a RF switch to transmit and receive. The 118 is a RF base band transceiver, with a low noise and power amplifier to filter receiving signals and transmit them. The 118 processes the frequency synthesizer that puts the data in the carrier, as well as the interface to the Host via USB or Mini PCI, PCI, Card bus, PCMCIA bus. 120 represents a MAC (Media Access Control) controller which has a CPU (Central Processor Unit) to handle the protocol of 802.11 such as DSSS (Direct Sequence Spread Spectrum), WEP (wired equivalent privacy) and AES (advanced encryption standard). The radio communication module needs to interface to a host for higher level of communication protocols and eventually the human interface level. Typically, wireless communication module uses 122, a mini-PCI bus, a PCI bus or a Cardbus to interface to the Host. The USB bus 124 also can be utilized to interface to the Host.

USB stands for Universal Serial Bus. It is the easiest way to connect computer peripherals to the PC (Personal Computer). Peripherals may include phone devices, audio devices, cameras, TV video devices, printers, data communication devices, etc. Implementing the USB on both PCs and peripherals is more economical due to the decreasing cost of the semi-conductor/IC to the sub-dollar level.

The increasing popularity of the digital camera surpasses the traditional file process camera because of its instant replay and computer storage and management. FIG. 3 shows a typical optical digital camera and digital voice block diagram for communication and storage. 130 are the optical lenses, and 132 is a CMOS or a CCD (Charge Coupled Device) that senses the RGB or BW photo which renders it in a matrix of pixels. The 134 is a multiplexer so that multiple lenses can be compressed by a single JPEG/MPEG IC (136). The 138 handles the compressed video to the Host via a USB or other microprocessor based Host bus. The 140 stands for a speaker for a human hearing device. The 142 denotes a microphone that senses and transfers the voice into an electronic form to the voice CODEC (Coding and Decoding) or 144. The 146 compresses the digital voice to G.723 (or other G.7XX standard) and communicates to the Host via a USB interface or other microprocessor base Host bus 148.

Flash Memory can re-write up to 100,000 times that of digital data and can the data even the power is off. The Flash Memory storage for the digital voice digital picture/video and digital vehicle motion recording can be in the forms of Security Digital (SD), Multi-Media card (MMC), Compact Flash (CF), Smart Media Card, or an IBM Microdriver Card. These Flash Memories can save the compressed voice/video as an MPEG 1/2/4, Motion JPEG, or JPEG for the video/digital voice such as G.723 or PCM codec scheme. The digital driving motion recording can also be stored in the Flash memory.

The planar antennas, including a microstrip, printed circuit antenna and other types of antennas that are flat in appearance and have a low profile, are easy to mass-produce. They have become a very popular design for cellular communication systems such as Global System for Mobile communication (GSM), the Digital Communication System (DCS), the Personal Communication System (PCS), the Universal Mobile Telecommunication System (UMTS) and Wireless LAN (Local Area Network).

FIG. 13 shows three types of planar antennas: A PIFA (Planar Inverted-F Antenna) antenna 150, a FR-4 printed circuit board antenna 170 and a Ceramic (Dielectric Resonator) Patch Antenna 180. The 150 PIFA antenna is a patch plane with a shorting point of 152 shorts the metal ground plane 154. The radiating top patch is fed through the wireless communication module PCB 158. 156 indicates the radio feed point from a wireless module to the antenna. The 170 FR-4 antenna is composed of a long and narrow PCB 176 and a radiating top patch of metal part 172 printed on. 174 specifies the feed point from the wireless communication module PCB 158 to the FR-4 antenna 170. The 180 is a Ceramic based small patch chip antenna. Because of its dielectric resonator material ability for mass production, the ceramic antenna is very common for GPS applications. The 182 is the Ceramic Dielectric material. The 186 is the planar metal part of the antenna and the 184 is a microstrip or a short coax cable connected to the wireless communication electronic module 158.

The Smart Card technology is one the latest technology for security and information world. Similar to the size of today's plastic payment card, the smart card has a microprocessor or an embedded memory chip. When coupled with a Smart Card Reader, it has the processing power to serve many different security applications. As an access-control device, smart cards make personal and business data available only to the appropriate users. Smart cards come in two varieties: memory and microprocessor. Memory cards simply store data and can be viewed as a small floppy disk with optional security. A microprocessor card, on the other hand, can add, delete and manipulate information in its memory on the card. Similar to a miniature computer, a microprocessor card has an input/output port operating system and hard disk with built-in security feature. Smart cards have two different types of interfaces: contact and contactless. Contact smart cards are inserted into a smart card reader, making physical contact with the reader. However, contactless smart cards has an antenna embedded inside the card that enables communication to the reader without physical contact.

The Motion/vibration sensor device and the G-force sensor device are useful for a vehicle to detect motion and vibration. Economically speaking, precision and the compactness of its size are very difficult to design for the ordinary vehicle.

Rather than the re-chargeable dry battery, lithium-ion batteries are widely used in the mobile phone world because of its high capacity of electricity and recharge capability.

In the case of the wires being cut by a professional thief, a mobile anti-theft device is powered by built-in battery.

The Ethernet network is a well-known communications network in the field of LAN communications, and is considered by many as the most popular LAN system in use today. In general, the Ethernet network provides for communications of computer data amongst user nodes attached to the network. A 10/100 Base-Ethernet system operates to transmit data packets from a source address to a destination address at a speed of 10 Megabits/second or a 100 Megabits/second. Ethernet IDE hard disk storage is becoming more popular for its convenience of Plug-And-Play, low cost and mass storage to a 100 Giga-Byte capacity. To install a car stereo or an alarm system, wiring is difficult and easy to break up by vibration or destruction by burglars. Therefore, additional equipment has to be designed for its rugged capability to the original manufacture car.

The recording of a vehicle while driving may be needed in the event of traffic accidents, traffic violations, and vehicle related crimes. All these instances can be recorded and replayed for liability analysis, the insurance companies or other purposes. However, traditional MPEG compression records too many frames per second for human visual continuity. Digital storage such as Flash memories are still expensive, have limited storage, and can only be overwritten for a number of times. As a solution, the smart sensor detects significant occurrences such as sudden acceleration, sudden breaks, vibration and flipping over, and triggers the camera to record faster shots. In normal situations, the video recording can be reduced to one shot per few seconds to condense unnecessary video shots to save memory.

While the GPS receiver for a vehicle is necessary, there are many setbacks. Some problems includes cost, difficult installation, quality of reception and coordination from the wireless communication device to the central control system. Moreover, the wireless Internet communications for a vehicle is inevitable for the cyber era. Similarly, there are problems of cost, difficult installation, safety utilization and compatibility with the PC/PDA/Hand-phone device to the human interface operation.

These problems lead to the invented device: Mobile-Safety-Communication (MSC) device of consolidated functions of front-view/rearview video/voice recording, vehicle motion recording, wireless communication with a planar antenna, GPS receiver with a planar antenna, USB/Ethernet communication, Flash memory storage of compressed Voice/Video/motion, smart card access, and an acceleration/vibration sensor. All of which are embedded into a rearview/side mirror or a stand-alone device attached to the proper positions onto the windshield glass. The MSC shall be easy to install and operate.

The voice and video recording portion and the GPS portion of the Mobile-Safe-Communication device (MSC) can be used for crime prevention and crime scene recording, emergency and accident recording, safe driving recording and management.

The wireless communication with GPS of the Mobile-Safety-Communication Device can be used for vehicle tracking in the incidents of car theft, emergency beacons, and trunk fleet management.

The wireless voice communication of the MSC can be used for emergencies such as earthquakes, tornados and car accidents. The voice communication also can be used for the management of commercial vehicles.

The wireless communication of MSC also can be used as a bridging adaptor between PCs/Notebooks and PDAs and USB or Ethernet connection for the functions of digital camera monitoring, wireless phone calling, GPS mapping and wireless broadband Internet access.

### SUMMARY OF THE INVENTION

The present invention is an electronic device that is comprised of a GPS receiver circuit module with planar antenna, wireless communication circuit module with planar antenna, digital cameras for both front-view and rearview with JPEG/MPEG compression, voice communication circuit modules with microphone and micro-speaker, vibration/motion sensor/gauge, Smart Card reader, Flash memory storage, USB of both Host and Devices outlet, Ethernet communication outlet, with a vehicle-DC and Lithium-ion battery to supply power in the most advantageous place for visual recording, where the radio reception and transmission are soldered in a small footprint of PCB and embedded into the enclosure of the rearview mirror or the side-mount rearview mirrors of a vehicle.

This invention can also be made into a stand-alone electronic device that can be mounted to the proper position of windshield glass of a vehicle for a better wireless communication transmission/reception and visual recording.

A key component of the present invention is the acceleration/de-acceleration/vibration sensor/gauge depicted in FIG. 18. Further this acceleration/de-acceleration sensor/gauge is connected to a micro-controller that identifies the significant driving occurrences for the central control unit to coordinate the voice/video/motion recording.

One objective of the present invention is to provide voice/video/motion recording and store it in either Flash memory or a hard disk. This information can be used in the circumstances of traffic accidents/violations, crime scenes and driving record management of commercial vehicles.

Another goal of the invention is to provide wireless communication for real-time voice as an intelligent warning broadcast during disaster cases such as war breakouts, earthquakes, and tornados. A normal wireless voice phone communication is also provided.

The automatic vehicle tracking is another target during a car theft or other emergencies. In these cases, the emergency beacon with a GPS position, vehicle ID and other useful information such as real-time video and voice will be asserted by wireless communication of the device and is operated with the Lithium-ion built-in battery in case of the vehicle DC power is cut-off.

The provision of the Internet broadband access via the wireless communication is another aspect of the invention. Internet access may be bridge with the PC/Laptop, or PDA via the USB or Ethernet interface.

The last component of the present invention is to provide the real-time video and voice communication between the driver and the privileged supervisor who has the two-way voice and one-way video communication scheme. This one-way video is very useful for overseeing the commercial vehicle fleet or the police forces in the real-time base so as not to obstruct the drivers view.

### BRIEF DESCRIPTION OF THE DRAWINGS

FIG. 1: A typical GPS receiver module with Antenna

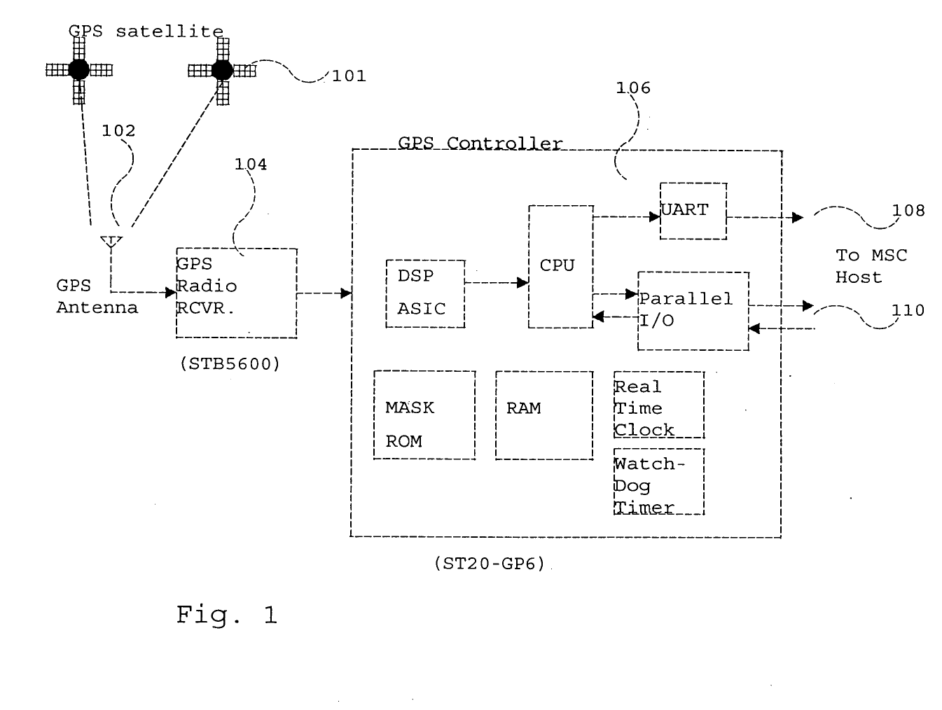

FIG. 2: A typical Wireless Communication module with Antenna

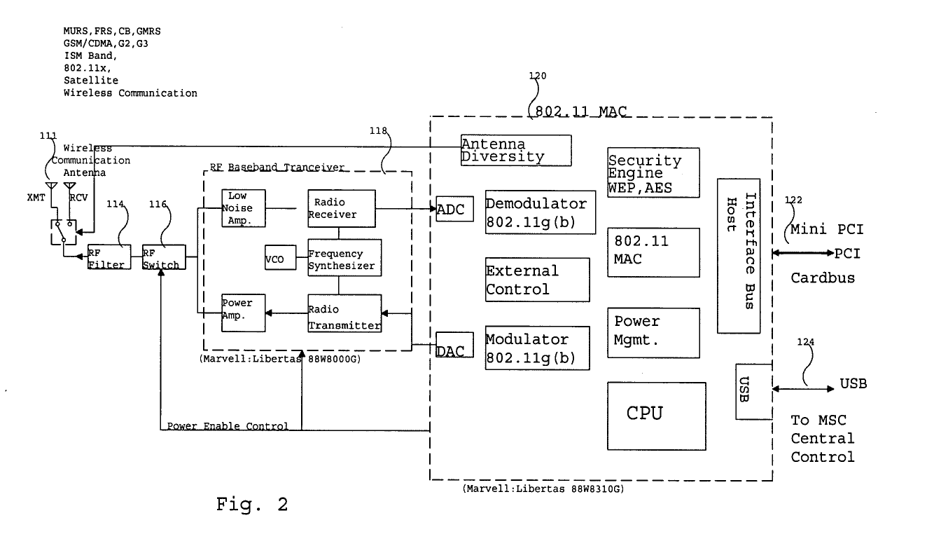

FIG. 3: A Rearview and front view digital camera with compression module and voice codec module block diagram for MSC.

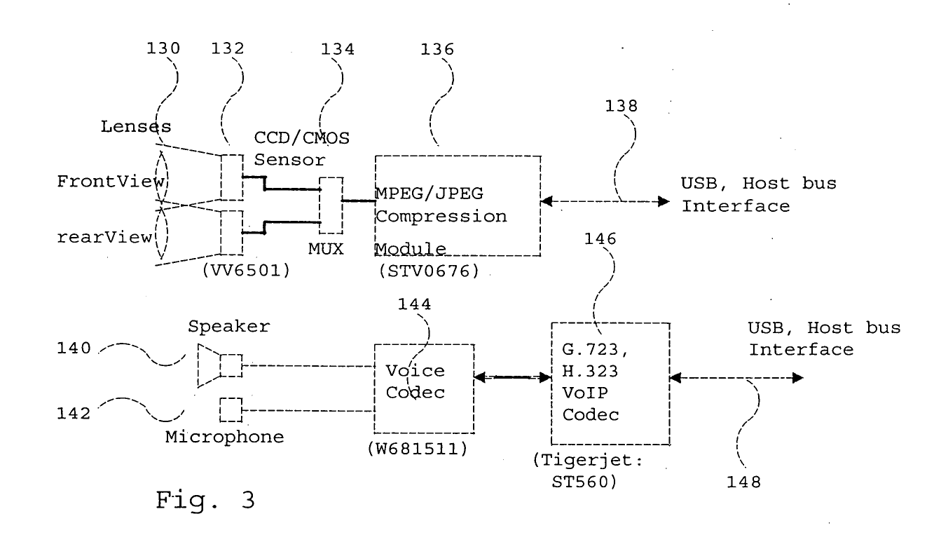

FIG. 4: A Central Control Module components block diagram for MSC.

FIG. 5 shows a block diagram of a Mobile-Safe-Communication (MSC) device with the Ethernet connecting to the MSC host according to an embodiment of the present invention.

FIG. 6 shows a block diagram of a Mobile-Safe-Communication (MSC) device with the USB connecting to the MSC host according to an embodiment of the present invention.

FIG. 7 shows an embodiment of MSC device using existing off-the-shelf components.

FIG. 8 shows installation positions of MSC device to a vehicle.

FIG. 9 shows a physical arrangement of MSC components embedded into a rearview mirror set.

FIG. 10 shows the method of operation flow chart of the MSC device including the normal operation scheme, the burglar alarm scheme, the USB/Ethernet Control scheme and the DRAM to Flash transfer scheme.

FIG. 11 shows an embodiment of MSC device embedded into a rearview/side-mounted mirror

FIG. 12 shows an embodiment of MSC device of a stand-alone version.

FIG. 13 shows different types of planar antennas.

FIG. 14 shows an embodiment of planar antenna of the GPS receiver of a MSC device

FIG. 15 shows an embodiment of planar antenna of the wireless communication of an MSC device.

FIG. 16 shows an embodiment of a Flash memory storage of Smart card, CF card, IBM Micro-device Card, SD card, MMC and memory stick interface design.

FIG. 17 shows an embodiment of Emergency button embedded in the central angle switch of a rearview mirror.

FIG. 18 shows an embodiment of acceleration/de-acceleration/vibration sensor/gauge component design of the MSC device.

FIG. 19 shows a MSC device connected to MSC host for mass storage Hard Disk.

FIG. 20 shows a MSC device receiving a phone call of an earthquake alarm or hands free supervisory management voice call.

FIG. 21 shows a MSC device connected to a Laptop PC as a bridging adaptor for functions including: digital camera monitoring, wireless voice communication, GPS mapping and wireless Internet broadband access.

FIG. 22 shows a MSC SOC containing the digital parts of MSC peripheral I/O including a USB hub, a JPEG/MPEG compression, a wireless communication DSP (Digital Signal Processor), and a GPS receiver DSP.

FIG. 23 shows an embodiment of MSC motion sensor/gauge with a micro-controller to identify MSC motion significant instances.

### DETAILED DESCRIPTION OF THE INVENTION

In accordance with the present invention, it provides an electronic device comprised of a GPS receiver circuit module with planar antenna, wireless communication circuit module with planar antenna, digital cameras for both front-view and rearview with JPEG/MPEG compression, voice communication circuit module with microphone and micro-speaker, vibration/motion sensor, Smart Card reader, Flash memory storage, USB of both Host and Devices outlets, Ethernet communication outlet, both mobile battery DC and Lithium-ion battery operated power supply all are arranged in the proper place for the better visual recording and radio reception and transmission. All of which are soldered in a small footprint of PCB and embedded into a rearview/side mirror of a vehicle. This device has been named as the “Mobile Safety Communication” (MSC) device.

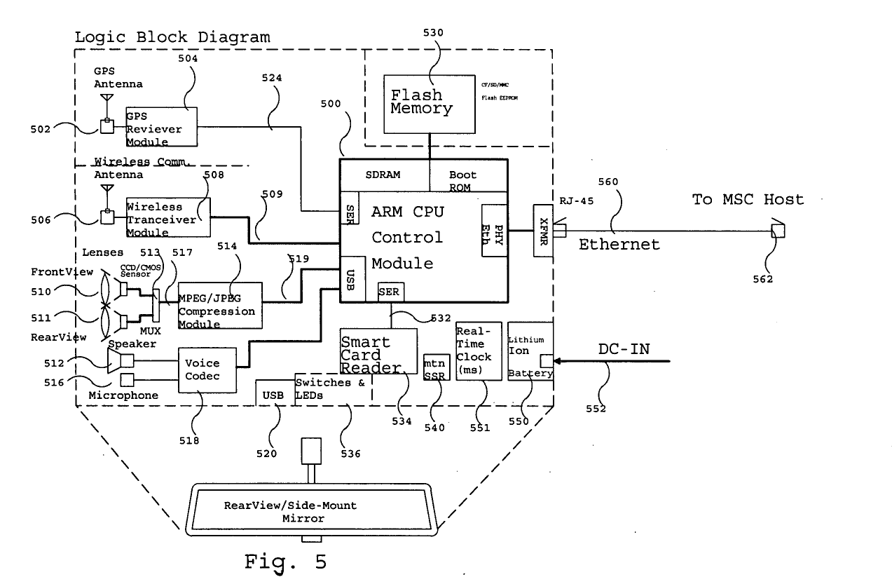

Referring to FIG. 5, a simplified schematic diagram of one embodiment of the present invention is shown. A planar antenna (502) such as a ceramic patch antenna is placed facing the sky to receive GPS satellite signals and connected to the input GPS receiver module 502 with a short coax cable. The GPS Receiver module 504 with an UART serial interface 524 connects to the Central Control Module 500 with the protocol and data of the GPS position. One embodiment of the GPS receiver module of MSC utilizes the STB5610 and ST20-GPS from ST Micro-Electronics. The GPS protocol interface can be found in the ST20-GPS user's manual and application notes.

Referring to FIG. 5, a planar antenna 506 such as FR4 microstrip printed circuit antenna placed facing front the of the unit is mounted on the highest possible position of the vehicle for better wireless communication and with a short coax cable connected to the wireless communication module 508. The wireless communication module 508, with host connection bus 509 such as USB, PCI, mini PCI, PCMCIA or Compact Flash, is interfaced to the Central Control Module 500. One embodiment of the wireless communication module of MSC utilizes the TI-TNETW1100B chip set from Texas Instruments. One embodiment of the wireless communication interface protocol between the MSC central control and the wireless communication module can be found in the application notes and user's manual from TI-TNETTW1100B.

Referring to FIG. 5, the front-view complex lens 512 is combined of optical lenses, a CCD/CMOS sensor and tilt/swivel mechanics for the precision photo focus on the CCD/CMOS sensor. The Pixel bus multiplexer 513 and pixel bus 517 from the CCD/CMOS sensor is connected to the JPEG/MPEG video compression module 514. The 513 is a multiplexer so that multiple lenses can be compressed by a single JPEG/MPEG IC (136) to save the space and cost for MSC. The JPEG/MPEG compression module compressed the picture/frame according the JPEG or MPEG1/2/4 standard and can be viewed by PC via the USB device outlet 520. The interface 519 between the MPEG/JPEG compression module 514 and the Central Control Module 500 can be a standard USB 1.1, USB 2.0 or other general standard microprocessor bus. The rearview lens complex 511 is the same as the front-view lens except that it is mounted behind the mirror where lens reflects the rear light that is designed for storing the picture. The special transparent portion of the mirror tint is where the rearview camera is installed behind the mirror and can be designed similarly to a tinted mirror. One embodiment of the MSC digital camera module utilizes the DUVIO NW 800. The CCD/CMOS sensor is controlled by the NW800 and indirectly controlled by the MSC central control via the USB interface.

Referring to FIG. 5, the microphone 516 and micro-speaker with an adjustable volume knob are needed for voice communication and shall be placed at the proper positions for maximum convenience and voice quality. The 518 is a voice codec and compression module and connects to the MSC central control via a USB interface. One embodiment of the voice codec utilizes the Tigerjet ST560. The voice codec implementation can be found in the user's manual and application notes from ST560.

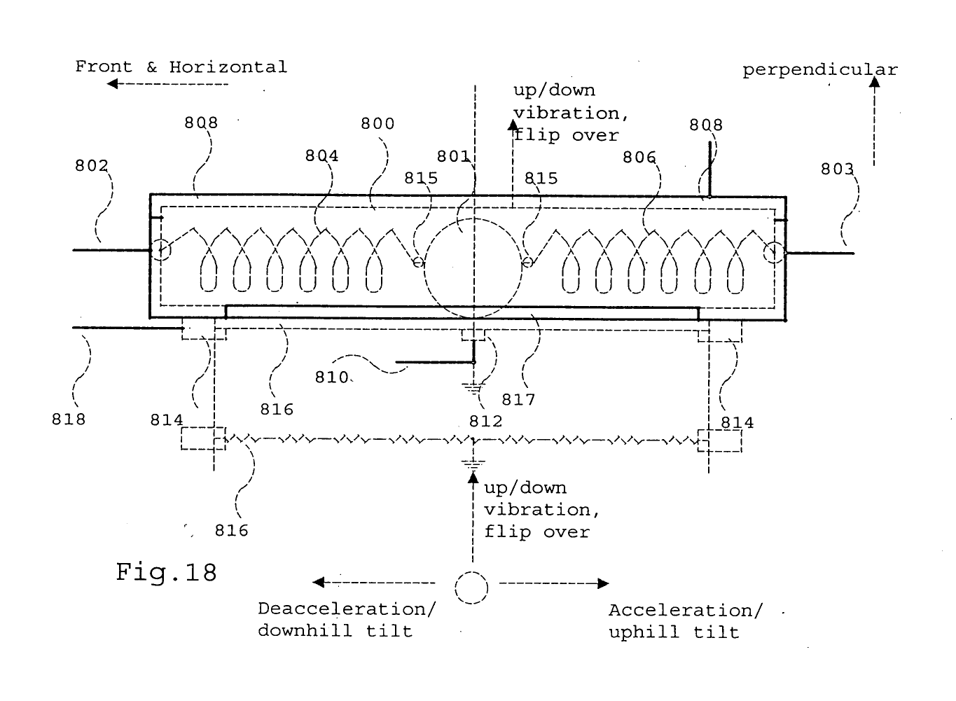

Referring to FIG. 5, the USB device outlet 520 is designed mainly to connect to a USB mobile memory stick that downloads from the built-in Flash memory for the digital voice/video/motion data of MSC. Other USB peripheral devices such as a printer, a LCD monitor or a voice communication device etc can also be connected. The 534 is a Smart Card Reader for detecting a contactless Smart card access as a security key. The 532 is a serial interface between the 500 Central Control module for the interface to Smart Card Reader. The 540 is a motion sensor/gauge or vibration sensor to detect the vehicle motion. One embodiment of the sensor/gauge is depicted in FIG. 18. The 550 is a built-in Lithium-Ion battery for emergency operation purposes. The 552 DC-In is connected to the Vehicle Battery for power supply in normal MSC device operation. 551 is a real-time clock with battery powered so that the accurate millisecond clock ticks even the vehicle power is off. After the vehicle owner setup the accurate time and date, the real-time clock 421 ticks by the millisecond for the time stamping of significant events. The 560 is a 10/100Base Ethernet to connect to a MSC Host 562 for mass storage such as large capacity Hard Disk.

Referring to FIG. 5, the Central Control Module 500 saves the digital data including vehicle motion, digital camera, digital voice and GPS position with millisecond time-stamps to the Flash memory 530 on each significant events.

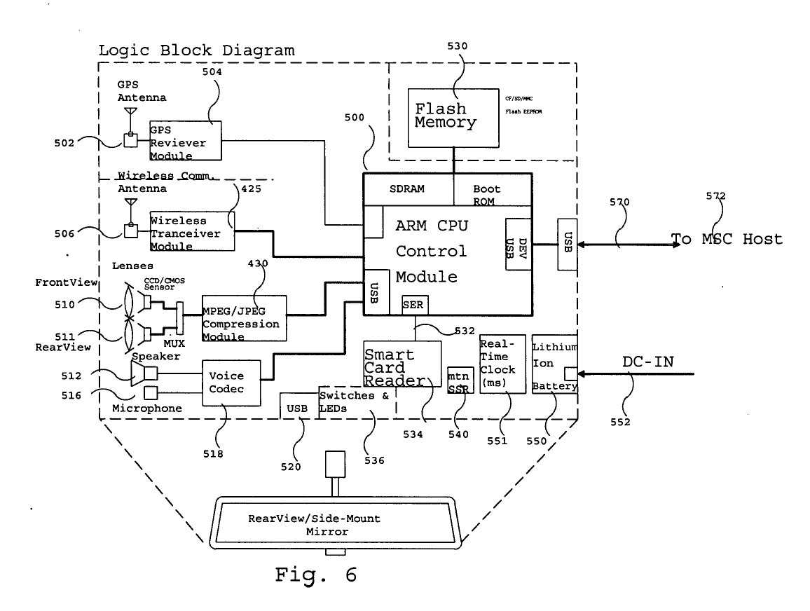

In FIG. 6, a simplified schematic diagram of one embodiment of the present invention is shown. FIG. 6 is same as FIG. 5 with the exception of the MSC device utilizing a USB connection 570 to a USB host 572 such as Laptop PC, PDA or USB Hard Disk storage.

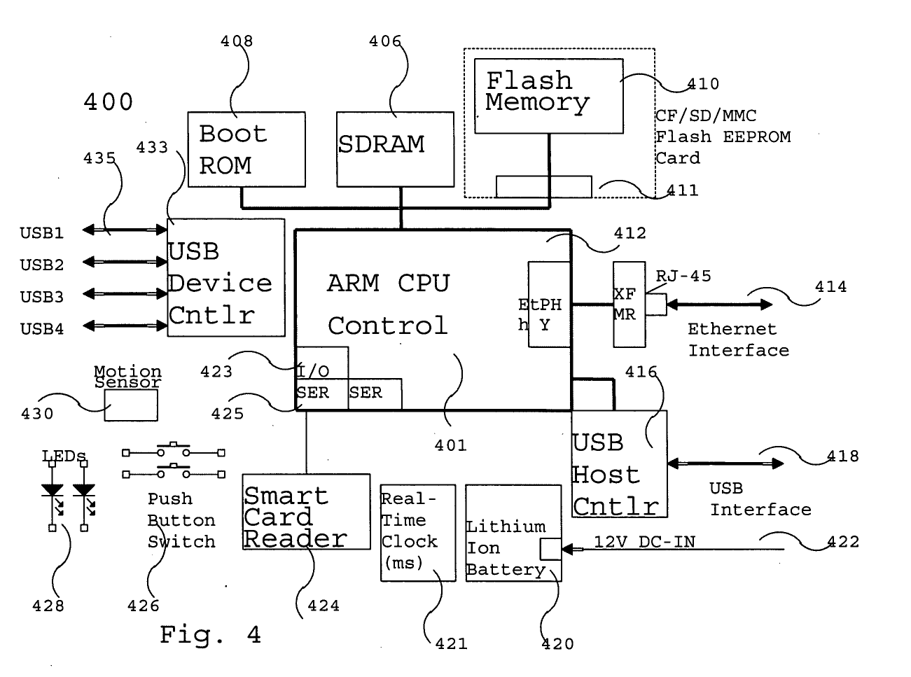

FIG. 4 portrays the Central Control Module 400. The 400 is mainly composed of an ARM RISC based CPU 401 with two or three Serial Interfaces 425, SDRAM interface 406 and Boot ROM 408. The 410 is a generic removable Flash Card with a 411 interface such as Compact Flash card, Multi-Media Card, Security Digital Card and Memory Stick. 416 is a USB device controller for connecting to the Laptop PC or PC host 418. The 422 is the DC power supply feed from the vehicle battery and regular charge to the Lithium-ion Battery 420. 421 is a battery powered real-time clock so that the accurate clock works even the vehicle power is off. After the vehicle owner sets up the accurate time and date, the real-time clock 421 ticks by the millisecond for time stamping significant events including digital camera shots and analyzing the vehicle speed. 424 is the Smart Card access and connected to the CPU 401 via a Serial Interface; 430 is a motion sensor connected to the I/O pins of the CPU 401; 428 is the LED indicator for showing the MSC device operational status. Lastly, the 426 is a switch button for MSC simple operation. One embodiment of the central control of MSC utilizes the Samsung S3C2410X. The software control is all embedded in the program memory in the central control module of MSC. The Central Control Module 400 saves the digital data including vehicle motion, digital camera, digital voice and GPS position with millisecond time-stamps to the Flash memory 410 on each significant events.

Referring to FIG. 4, the MSC central control module uses USB device control Hub 433 and multiple USB interface 435 to interface to the MSC peripherals including: Voice communication module, Digital Communication Module, MSC USB outlet. MSC central control module also has an Ethernet MAC controller 412 and interface to a MSC host via the Ethernet Interface 414. The 423 is generic I/Os of MSC central control including TTL I/Os, I2C serial interface and Serial EEPROM configuration interface.

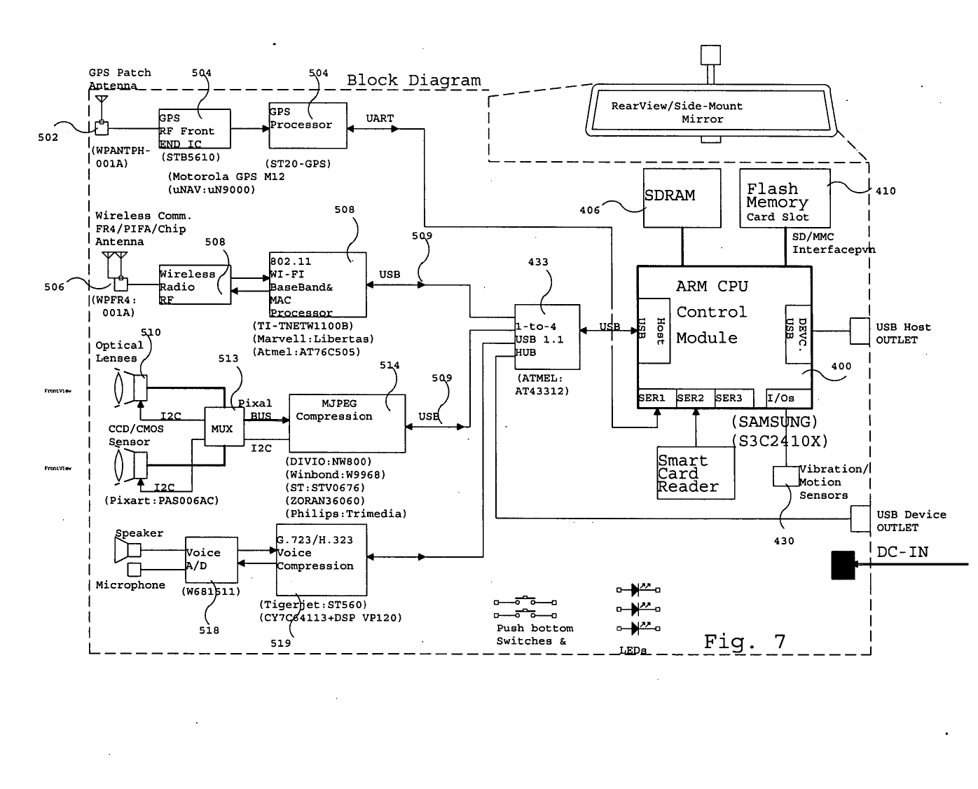

FIG. 7 shows the present invention using off-the-shelf component to implement the MSC. As numbers indicate in the FIG. 5 and FIG. 6, the 502 can be the World Product WPANTPH001A for the GPS Ceramic Chip antenna, the 504 can be STMicroelectronics ST5610 and ST20-GPS, Motorola GPS M12 or uNAV: uN9000. The 506 can utilize the World Product WPFR4001A as the wireless communication planar antenna; the 508 can be a Marvell Libertas chip set or the TI-TNETTW1100B or the Atmel: AT76C505 for the 802.11 wireless communication module; the 510 CCD/CMOS optical sensor can be the Pixart: PAS5006AC and multiplexer 513 can use the Lattice MACH CPLD series component. The 514 MPEG/JPEG can serve as the DIVIO: NW800 or Winbond: W9968 or the STMicroelectronics: STV0676, ZORAM36060 or the Phillips: Trimedia. The 518 voice codec can be the Winbond W681511 or the Tigerjet:ST560 (519). The 433 USB repeater is a USB Hub such as the ATMEL. The 509 is the USB interface that connects between USB host and USB device. T43312; the CPU 400 can be the Samsung S3C2410X; the 406 can be MICRONS MT48LC16M16A2TG; 410 Flash Memory can be an Intel 28F640L18; and the 430 Vibration sensor can be SCM International Inc. (NMS24M).

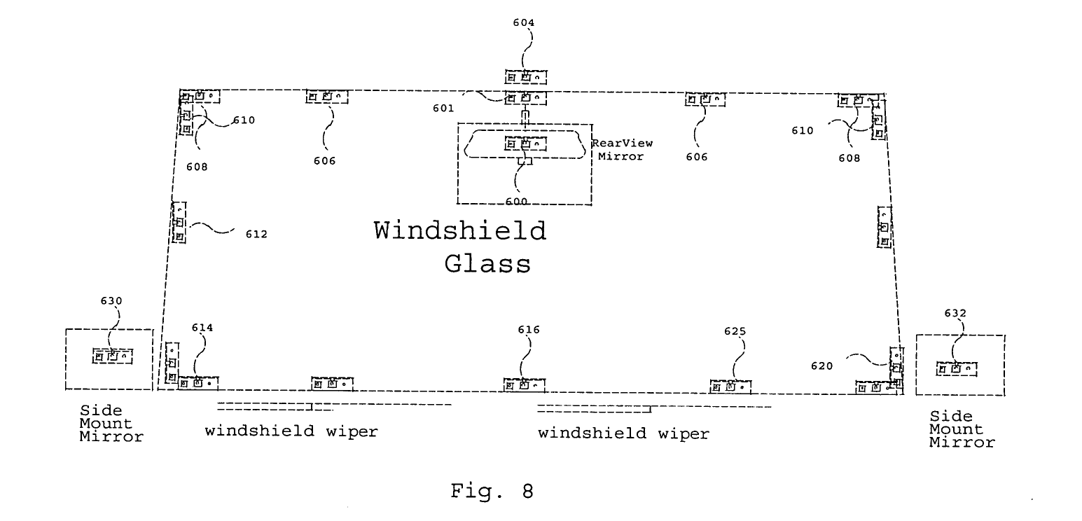

FIG. 8 shows the potential positions for the MSC device within a car. Placing the GPS antenna facing the sky results in better reception. For the wireless antenna, the higher the antenna is placed, the better the wireless connection. Therefore, the positions 600, 601, 606, 604, 608 and 610 are better positions. Positions 614, 616, 625, 630 and 632 are less preferred. Positions 630 and 632 shows the MSC device mounted in the side mirrors. Among these positions, 600 is the best place to put the MSC device because of the following reasons: easy installation, trouble-free operation and control, better wireless transmission/reception, enhanced voice communication for the driver, the front-view/rearview digital video recording.

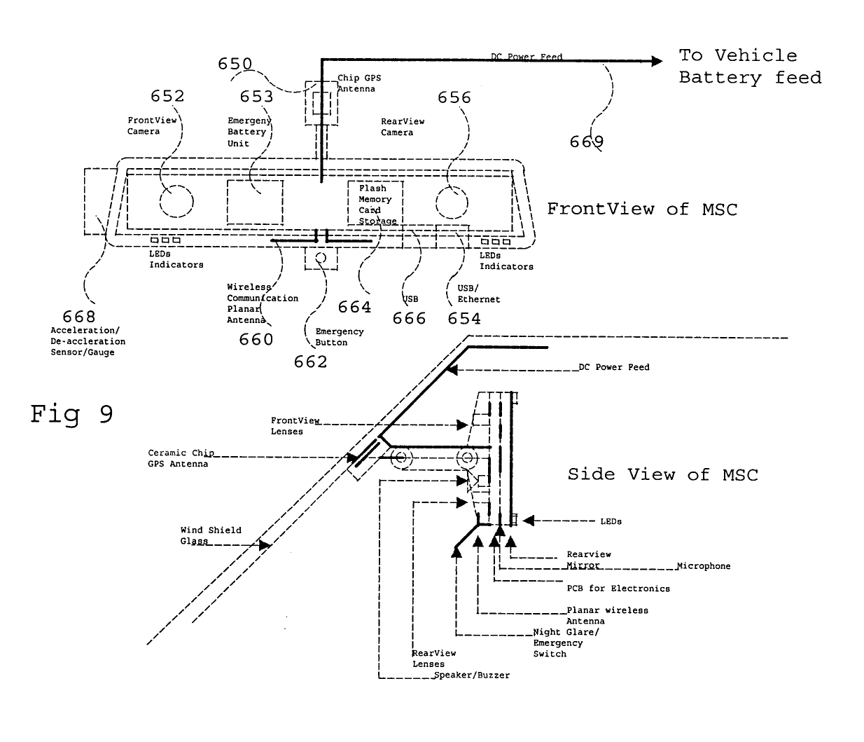

FIG. 9 shows the interface component arrangement of a MSC device in a rearview mirror. 650 is a ceramic chip antenna of a GPS receiver; 660 is the FR-4 planar antenna for wireless communication, 652 is a front-view digital camera CCD/COMS sensor; 656 is a rearview digital camera CCD/CMOS sensor; 664 is the removable Flash Memory housing; 662 is the emergency button on the anti-glare flip at the lower center position of the rearview mirror; 666 is the USB outlet for downloading stored digital data including the video/voice and driving motion; 654 is the USB or Ethernet outlet to the MSC Host such as an Ethernet hard disk mass storage; 669 is the feed from the vehicle battery power supply; 668 is the acceleration/de-acceleration sensor gauge; 653 is the auxiliary DC power supply of Lithium-ion battery.

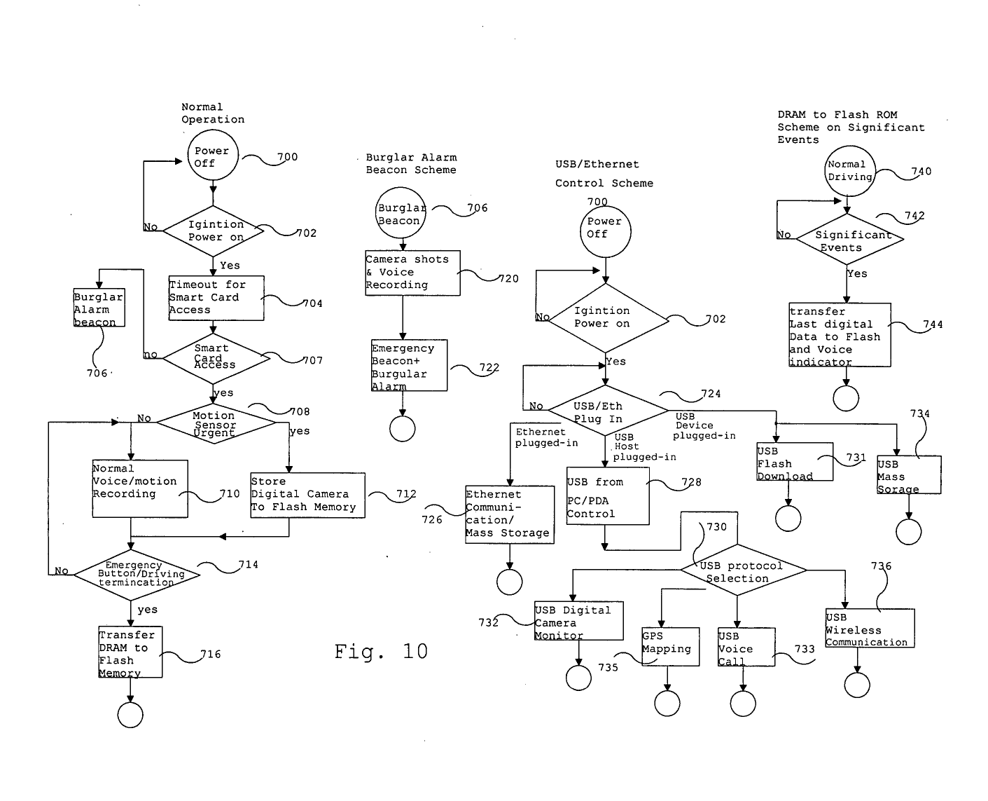

FIG. 10 shows the method of operation of the MSC flow chart. Starting with normal vehicle operation scheme 700: when the vehicle's ignition is turned on as depicted in 702, within few seconds timeout 704, the Smart Card hangs onto the neck ribbon of the driver who has to access to the MSC for the secure/ownership or 707. Otherwise, a burglar alarm/beacon will turn on (706) even the vehicle's DC power supply feed been cut off. This demonstrates the best anti-theft feature of the MSC device. During driving, the MSC motion gauge keep identifying the significant instances of the driving motion (708), when 708 identifies the normal driving instance, the voice codec/compression will record in the DRAM for a couple of seconds, then the digital voice is saved in a 8 MB Flash Memory as depicted in 710. With the limitation of the read/write times of Flash Memory, the life cycle for the 8 MB digital voice memory space is at least 1,111,111 driving hours (assuming the Flash Memory read/write times exceeding 100,000 times). The digital voice is 16K-bit (2K-Byte) per second and every 32-second worth of 64K-Byte will be stored in the memory stick. In the normal driving 710, the steady state identified by the MSC motion gauge will result in less shots per second for the digital camera recording. Also in the normal driving 710, the normal break and normal acceleration identified by the MSC motion gauge, the digital camera shall take more shots per second to record these significant instances. In sudden break instances identified by the motion gauge, the digital camera will take the shots and store it in the Flash memory in case of an accident or the loss of the vehicle's power supply as depicted in 712. When driver pushes the emergency button or terminates the driving as depicted in 714, the MSC will transfer all the last recorded voice/video/motion information from DRAM to built-in Flash memory as depicted in 716.

Also referring to FIG. 10, the Burglar alarm beacon scheme 706, the vehicle ID, GPS position, and other useful information such as front-view/rearview digital camera shots or the voice recording 720, can be broadcasted regularly as the emergency radio beacon 722. As to the USB/Ethernet interface operation, when a USB or Ethernet device has been plugged into the MSC as 724, the MSC Ethernet host is able to command the MSC to record the voice/video/motion and GPS information to a mass storage as 726. In the case of a USB Host device, such as a laptop PC or PDA is plugged in as 728, the electronic and firmware of MSC is intelligent enough to tell which kind of MSC host device and reacts accordingly. With a USB protocol 730, the MSC can display the digital camera view 732, GPS mapping display 735, USB voice control such as dialing out to an IP phone 733 or a USB wireless communication to Internet Broadband 736. When a removable USB device, Flash memory disk 731 or USB mass storage 734 is plugged in, the MSC will download the latest current recorded information to the USB disk.

Also referring to FIG. 10, transferring DRAM to Flash memory scheme 740: when an abnormal instance 742 including vehicle collision, sudden break or sudden acceleration identified by the motion sensor/gauge, the digital data including last shot from digit camera, last few second voice, last few second vehicle digital motion, GPS position from the DRAM shall be save in the Flash memory in case of power been cut off as indicated in 744. Also in 744, an audible voice signaling shall be heard to the driver to indicate the last scene has been saved in the Flash memory. The significant saved data in the Flash memory will not be overwritten until an authorized Smart Card access to release the lock of the significant save data.

Referring to the FIG. 18, the digital vehicle motion is similar to the voice codec because the motion sensor/gauge 800 is designed similarly in the way of linear motion to the voice vibration. The silence is similar to the double-spring attached metal ball 801 in the center of film resistor 816. Due to the huge memory space that is required to store the visual recording, and the limited write time for Flash Memory, the digital camera has to be carefully designed. The frame rate has to coordinate with the motion sensor/gauge. A shot has to be taken when the metal-ball (800) moves from the center position, which means that the vehicle is moving. Then, depending on the motion while the vehicle in a steady state of driving or stopping, a shot can be taken every few seconds to one shot per second as the video recording slowly (710) in FIG. 10. As the metal-ball moves faster, more shots need to be taken as indicated by Faster Video recording (712). The further away from the center the metal-ball's position, the more shots that needs to be taken. However, this situation has to compensate the tilting of the vehicle from the level line in case of up/downhill. These pictures will be taken and compressed in the DRAM first, and in the case of emergency or if the car terminates the driving (714), the digital pictures stored in the DRAM will be transferred onto the Flash Memory with Vehicle's battery or the emergency Lithium-ion battery as depicted in 716. This way, the Flash Memory can be used for at least 100,000 times for digital picture recording. By hitting the emergency button, the abnormal acceleration/de-acceleration or flipping of the vehicle is detected by sensor 800, the emergency radio beacon will be asserted along with the vehicle's ID, GPS position, digital pictures/voice, and motion status information. For the duration of the last seconds of video shots, voice recording residue in the DRAM will be stored in the Flash Memory with a DC power supply by the vehicle's battery or Lithium-ion battery as shown in 716. At least a 64M-byte memory for the digital video can store pictures of 480×400 pixels, for 400 pictures before and after the emergency situation. When an external USB or Ethernet device is plugged in the MSC device 724, the Central Control Unit will automatically sense what kind of device that has been plugged in. When a USB Flash Memory Disk is plugged in, the MSC will download the recent video/voice/motion digital data to the USB Flash Memory Disk as depicted in 731. If Laptop PC is plugged in 728, the MSC device will serve as a wireless terminal bridge (736), voice communication device 737, digital camera 732 or upload the Flash Memory as the Laptop PC commands. In a 10/100 Base Ethernet is plugged in, the MSC 726 will send the video/voice/motion recording information to a MSC host mass storage hard disk (734) via the Ethernet Connection.

The MSC shall time-stamp all the significant events to the millisecond accuracy by using the Real-Time Clock in the Central Control module. Referring to FIG. 4, 421 is a real-time clock. After the vehicle owner setup the accurate time and date, the real-time clock 421 ticks by the millisecond for the time stamping of significant events including digital camera shots, vehicle abnormal motion identified by the motion sensor/gauge and transferring the DRAM to Flash memory. To re-construct the vehicle accident scene interval, the speed and motion of the vehicle can be analyzed by the accurate time-stamped digital pictures.

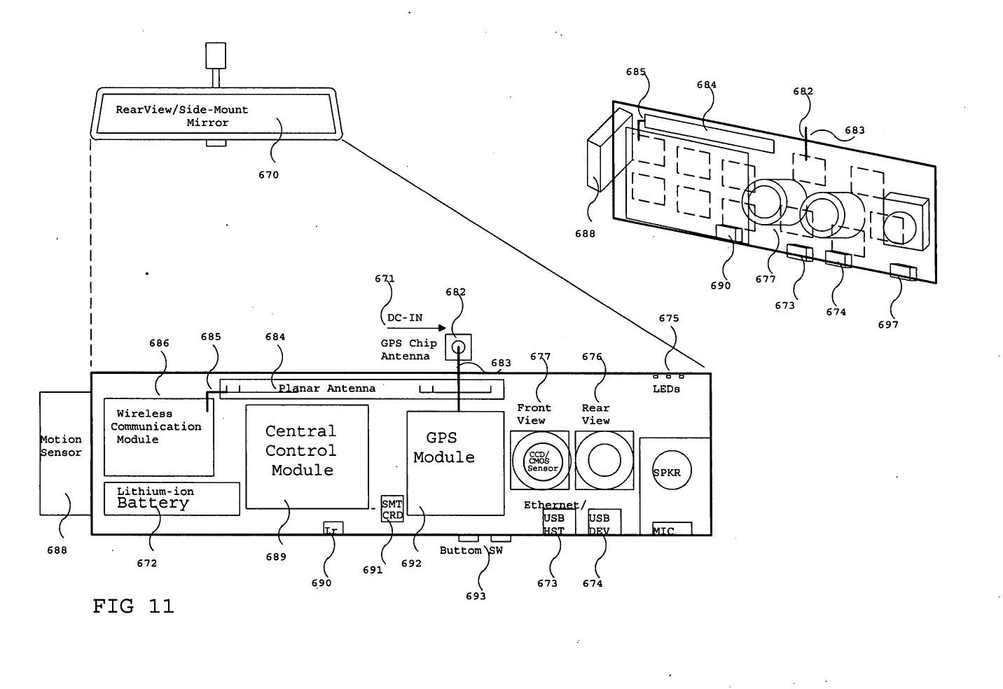

FIG. 11 shows the component's physical arrangement of the MSC device embedded into the rearview mirror. 670 represents the rearview mirror; 671 is the vehicle DC battery feed; 672 is the built-in Lithium-ion battery; 673 and the USB/Ethernet outlet to the MSC host; 674 is the USB outlet for download the Flash memory; 675 is the LED operating status indicators of the MSC device for the driver; 676 is the rearview digital camera lens; 677 is the front-view digital camera lens; 682 is the ceramic chip patch antenna for GPS receiver; 683 is the short coax cable to the GPS receiver module (692), 684 is the wireless communication antenna; 685 is the feed of the radio signal to and from the wireless communication module; 686 is the wireless communication module, 688 is the acceleration/de-acceleration sensor/gauge; 689 is the Central Control Module, 690 is the Infra-Red communication link to the remote control; 691 is the Smart Card access; 692 is the GPS receiver module; 693 are the button switches.

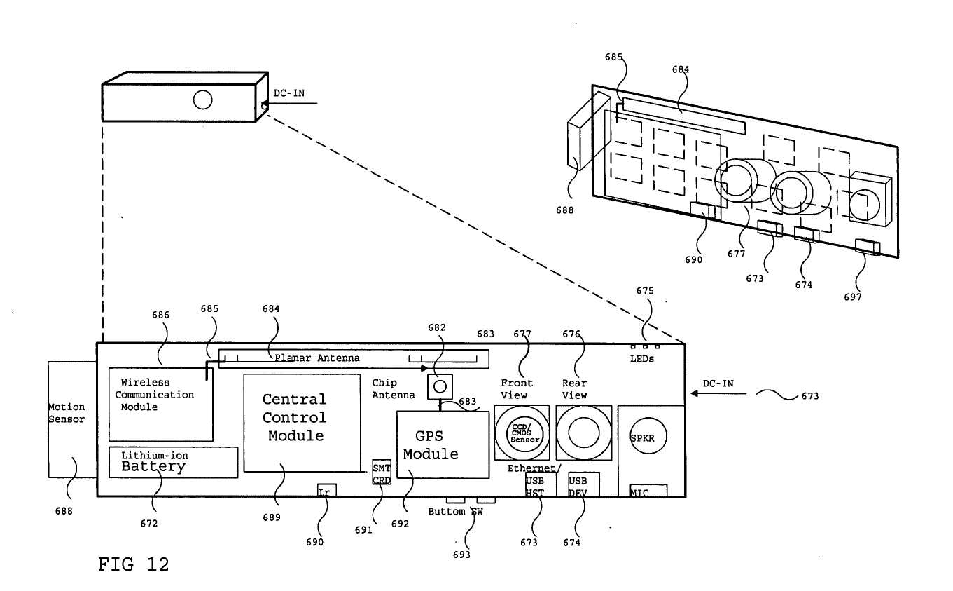

FIG. 12 is similar to FIG. 11 except that it is embedded into a stand-alone MSC unit and the GPS ceramic chip antenna is placed facing the sky.

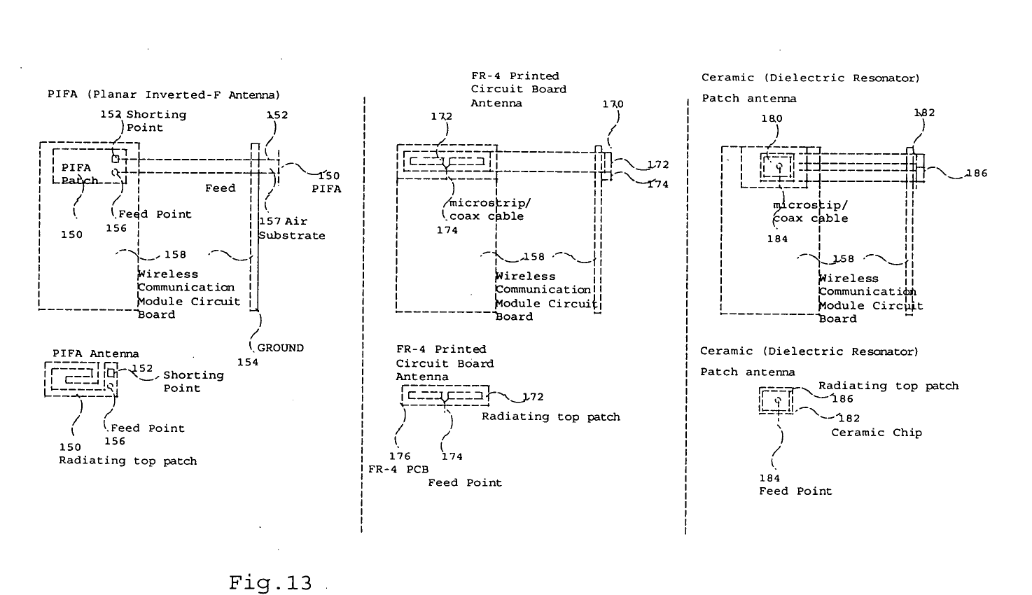

FIG. 13 shows the typical planar antenna: 152 is a PIFA antenna, 170 is a FR-4 printed circuit antenna and 180 is a ceramic chip patch antenna.

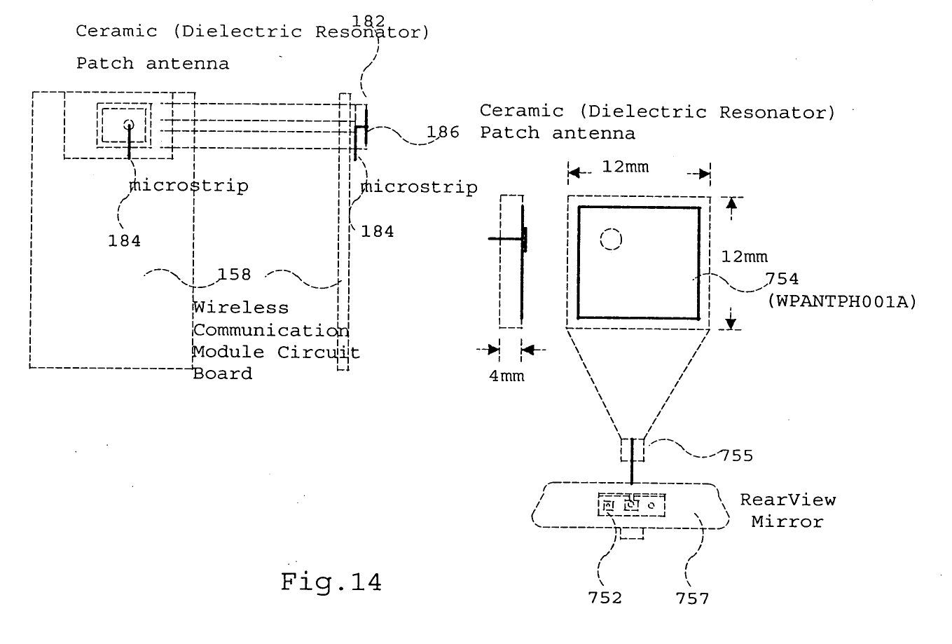

FIG. 14 shows one embodiment of the GPS antenna design in a MSC device. 186 is the top metal patch to the ceramic chip; 182 is a dielectric material; 184 is a microstrip or a 50 ohms coax cable connected to the GPS receiver electronics 158. 754 can be the World Product WPANTH001A ceramic chip antenna. 755 shows how the chip antenna 754 fit into the part of a rearview mirror 757 so that the chip antenna 754 is facing the sky on the windshield for better GPS radio signal reception. 754 needs to be connected to the GPS receive module of the MSC electronic 752.

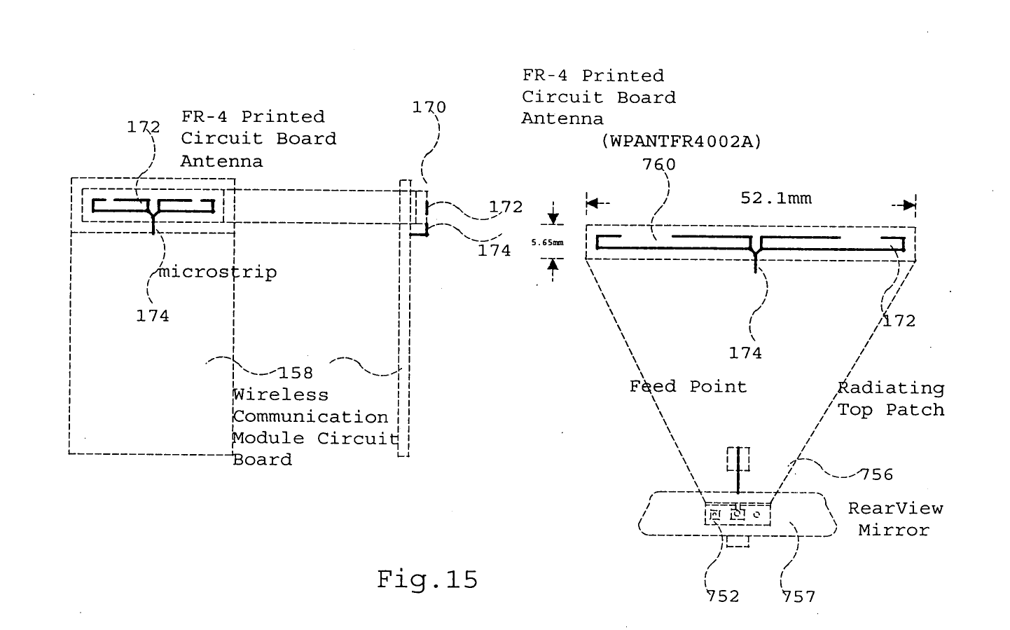

FIG. 15 portrays the wireless communication antenna design of the MSC device. 172 is a printed circuit FR-4 antenna trace; 174 is a microstrip or a 50 ohms coax cable connected to the wireless communication electronics 158; 760 can be the World Product WPANTFR4002A FR-4 printed circuit board or other similar one. 756 shows how the FR-4 antenna fit into the rearview mirror 757 so that the FR-4 antenna 760 is at the higher level on the windshield for better wireless communication. 760 needs to be connected to the wireless communication module of the MSC electronic 752.

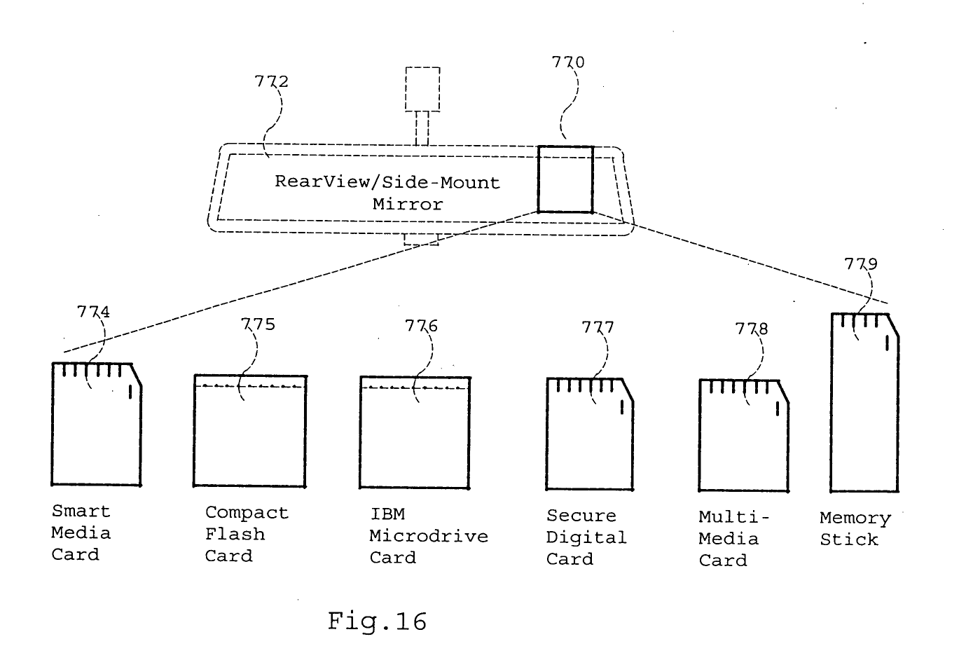

FIG. 16 shows the removable Flash Memory mechanical design of the MSC device. The 772 is the rearview mirror; 770 is the housing for removable Flash Memory Card; 774 is a Smart Media Card; 775 is a Compact Flash Card; 776 is a IBM Micro-drive Card; 777 is a secure Digital Card; 778 is a Multi-Media Card and 779 is the memory stick.

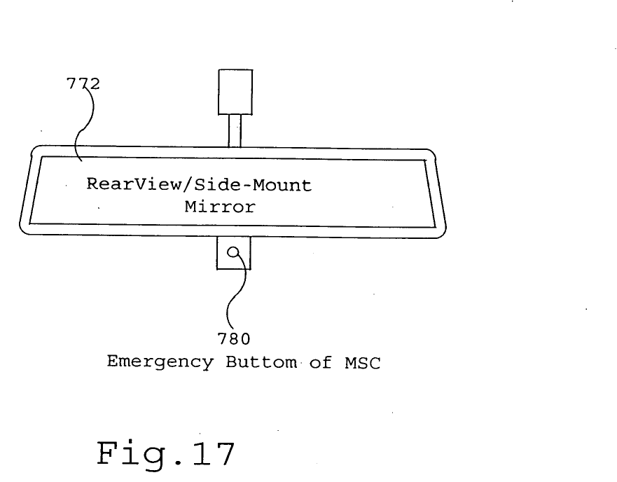

FIG. 17 illustrates the emergency button on the anti-glare flip portion of a rearview mirror. 780 is the emergency button and 772 is the rearview mirror.

FIG. 18 shows an acceleration/de-acceleration sensor/gauge or a motion sensor/gauge of the MSC. 800 is a double spring based metal-ball for acceleration/de-acceleration sensor/gauge; 801 is the metal-ball with both left and right side soldered to a metal spring 806/804 via the solder joint 815s. The distance of the metal-ball 801 from the center position correlates to the acceleration/de-acceleration force applied to the vehicle. The strip type of electronic film resistor 816 is laid under the metal ball and confined by the metal ball track 817. This is the key design to precisely measure the dynamic and static movement of the center of the metal ball. 810 is the center tap lead pin of the resistor; 812 is the center position metal pad and connected to the Ground Reference; 814 is the metal pad connected to both sides of the strip film resistor. 812 is the ground reference; the acceleration of the vehicle can be measured by the movement/resistance from 803 to 812; the de-acceleration can be measured by the movement/resistance from 802 to 812. The abnormal acceleration/de-acceleration can be analyzed by the G-force of the metal-ball movement/resistance. 808 is the top metal part for the vibration or flip sensor of the vehicle. When the metal-ball 801 taps 808 means the vehicle is vibrating up and down. When the metal-ball touches 808 for a long time, this indicates that the vehicle is flipped over.

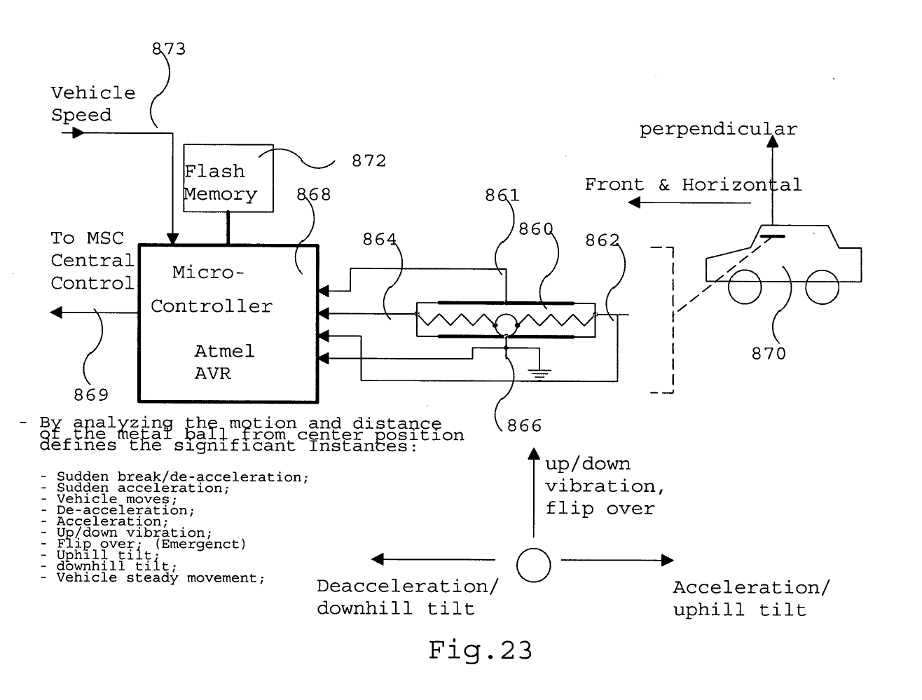

One embodiment of the MSC motion sensor/gauge is shown in FIG. 23. 870 is a reference direction of a vehicle with MSC device. A MSC motion senor/gauge 860 with a micro-controller Atmel AVR series micro-controller 868 which has A/D and D/A function can identify the significant motion instances for the MSC central control 869 by analyzing the metal ball movement. The metal ball movement can be measured by the electronic resistance from 864 to 862 for the acceleration, by the electronic resistance from 864 to 864 for the de-acceleration/break, by the metal ball contact to the 861 for the up/down vibration or permanently contact 861 for the flip over condition. The 868 micro-controller can identify instances such as sudden break/de-acceleration, collisions, sudden acceleration, vehicle move steadily, acceleration, de-acceleration, flip over instances, up/down vibration, uphill tilt and downhill tilt by analyzing the metal ball movement. Furthermore, the speed input 873 from the vehicle speed meter, the MSC motion sensor/gauge can record the full driving motion including acceleration, de-acceleration, impact, vibration and flip over and save in the Flash memory 872.

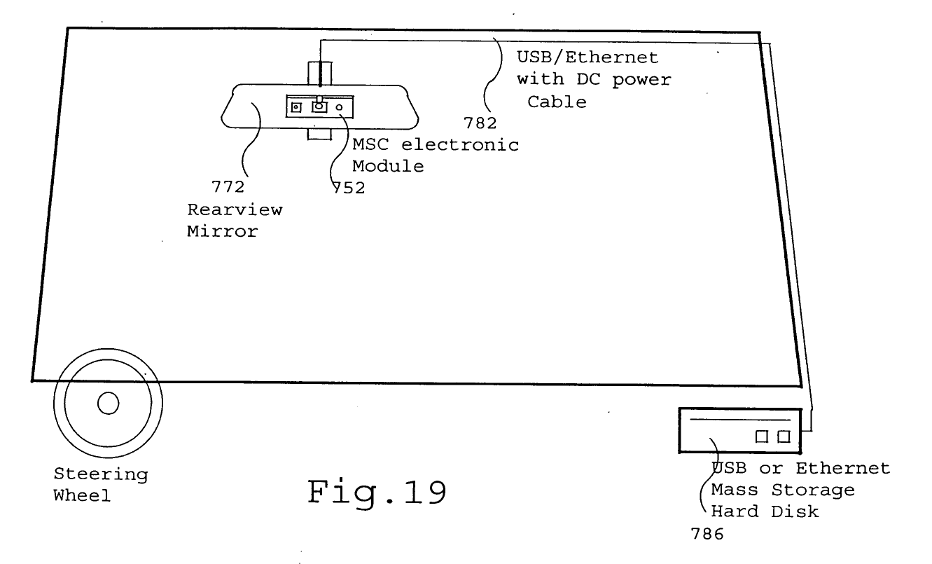

FIG. 19 shows one embodiment of the MSC device connecting to mass storage of a MSC host. 752 is a MSC electronic module; 772 is the rearview mirror and 786 is the mass storage of USB/Ethernet hard disk. 782 is the cable that includes a USB or Ethernet wiring and the +12V DC feed to the MSC. The voice recoding, digital camera shots and the motion recoding data can be sent to the MSC mass storage via the USB or Ethernet interface. The purpose of the MSC mass storage is to record the long period of driving including voice, video and motion. This feature is very beneficial for the commercial vehicle operational management.

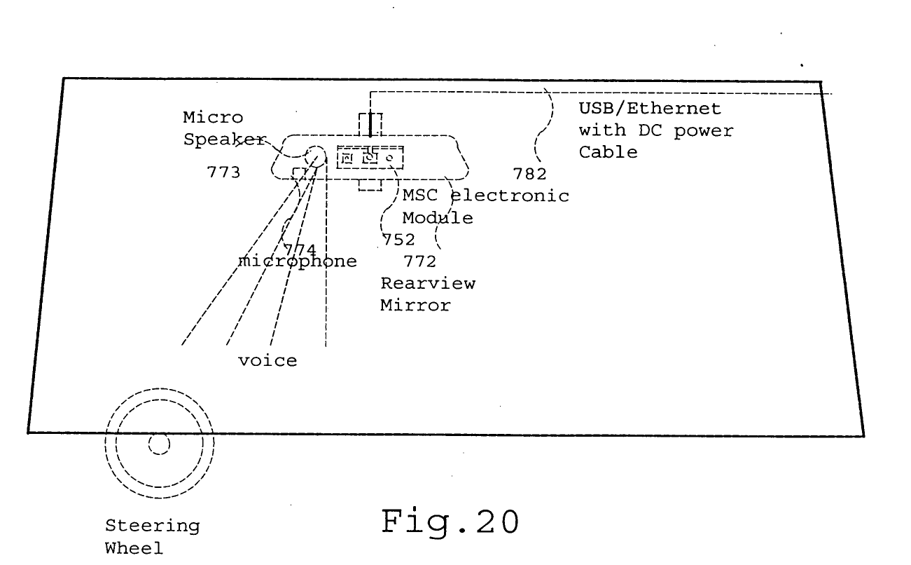

FIG. 20 shows how a driver receiving the earthquake alarm of a hands-free voice communication of MSC: 773 is the micro-speaker in the rearview mirror 772, 774 is the microphone to pick the voice of the driver if necessary, 752 is the MSC electronic main module. 782 is the DC power and USB/Ethernet interface cable feed.

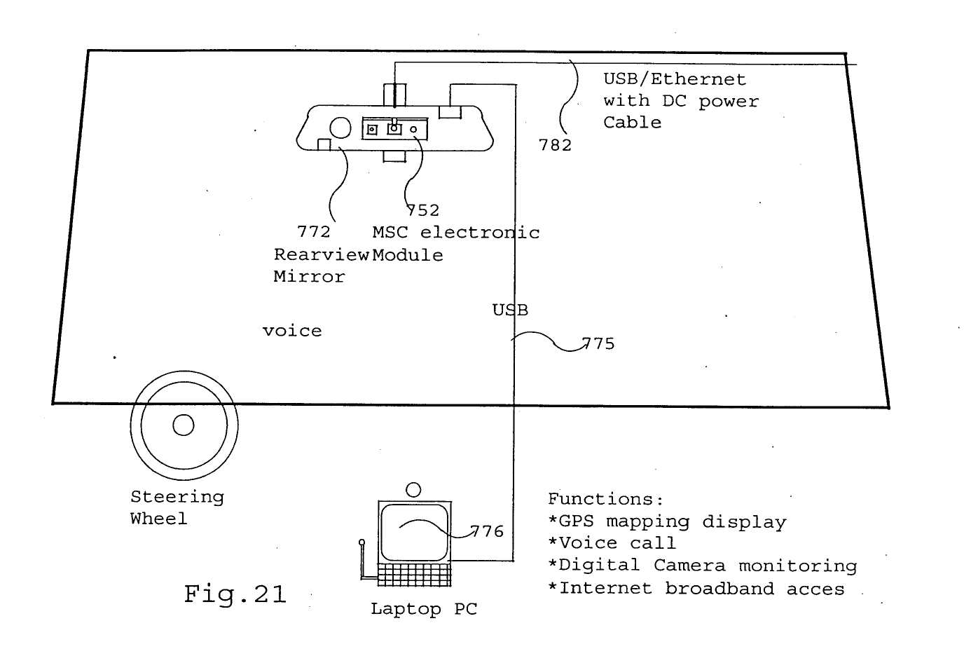

FIG. 21 shows a laptop PC as a MSC host connected to the USB outlet of the MSC to perform MSC functions; 776 is the laptop PC with a USB connection 775 linked to the USB host outlet of MSC 777. The 776 laptop PC can perform the GPS mapping diagram, real-time digital camera display of front-view and rearview, Internet broadband access or IP voice call on the display. 782 is the DC power and USB/Ethernet interface cable feed. 772 is the rearview mirror with the MSC electronic main module 752.

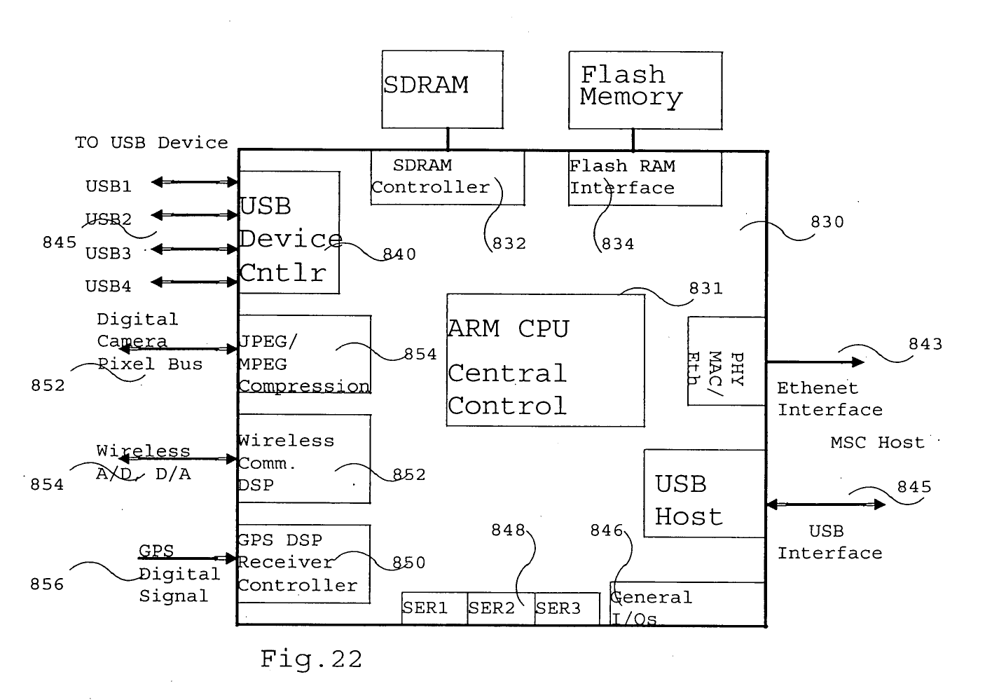

FIG. 22 shows a MSC SOC contains the digital parts of MSC I/O peripherals including USB Device Controller Hub, JPEG/MPEG compression logic, wireless communication DSP (Digital Signal Processor), GPS receiver DSP. 830 is a SOC (System On Chip) of a MSC which includes the following module: ARM CPU central control 831, SDRAM controller 832, Flash RAM interface 834, USB device HUB controller 840, JPEG/MPEG compression logic 854, wireless communication DSP 852, GPS receiver DSP 850, multiple Serial I/O 848, general I/Os 846, USB host controller 844 and Ethernet MAC/PHY 842. 845 is the USB device port for MSC USB outlet. 852 is the pixel bus to the CCD/CMOS sensor of digital camera. 854 is the interface to the wireless communication analog circuit module. 856 is the interface to the GPS receiver RF analog circuit module. 843 is the Ethernet outlet of the MSC and 845 is the USB host interface to a MSC host such as laptop PC.

What is claimed is:

1. An electronic circuit system named Mobile Safety Communication (MSC) device embedded into a rearview/side mirror of a vehicle comprising:
a GPS receiver circuit module with a planar antenna;
a wireless Communication circuit module with a planar antenna and a USB interface;
a plurality optical lenses and CCD/CMOS sensors with single JPEG/MPEG compression circuit module and a USB interface;
a RISC CPU based central control module circuit having a plurality of UART serial control ports, a plurality of USB device control ports, a plurality of USB host control ports, an Ethernet network ports, a DRAM and Flash Memory controllers, and the central control processor executing MSC software;
a Real-time clock with battery;
a Smart Card Access host electronics module;
a Flash memory storage;
a Lithium-ion battery;
vibration and motion sensor/gauge with a micro-controller;
both USB Host and USB Device outlets;
Ethernet Communication outlet;
wherein all of these electronics circuit modules soldered in a PCB and embedded into the rearview or side mirror of a vehicle.

2. The Mobile Safety Communication (MSC) device according to claim 1, further molded into stand-alone unit is mounted at the proper position to the windshield glass of a vehicle.

3. The MSC device according to claim 2, wherein the proper positions of the windshield glass are mounted at the highest position for better wireless communication and with GPS planar antenna facing the sky and better visual recording positions of a vehicle.

4. The MSC device according to claim 1, an electronic circuit IC (Integrated Circuit) package in a SOC (System On Chip) form that comprising:
a RISC CPU central control module;
a digital signal processing part of GPS receiver module;
a digital signal processing part of wireless Communication module;
a digital camera pixel bus with JPEG/MPEG compression circuit module;
a plurality UART serial I/O ports;
a flash memory;
a plurality USB host and device control ports;
an Ethernet communication circuit.

5. The MSC device according to claim 1, wherein a wireless communication module that includes but is not limited to GMS, CDMA, 802.11, MURS, FRS, GMRS, HAM, CB radio communication with planar antennas embedded into the vehicle's rearview or side mirror.

6. The MSC device according to claim 2, wherein a wireless communication module that includes but is not limited to GMS, CDMA, 802.11, MURS, FRS, GMRS, HAM, CB radio communication with planar antennas embedded into stand-alone unit is mounted at the proper position to the windshield glass of a vehicle.

7. The MSC device according to claim 5, wherein a printed circuit trace (FR-4) antenna, a ceramic chip antenna or a PIFA antenna of the wireless communication is applied to the rearview/side mirror of a vehicle.

8. The MSC device according to claim 6, wherein a printed circuit trace (FR4) antenna, a ceramic chip antenna or a PIFA antenna of the wireless communication applied to a stand-alone unit which is mounted at the proper position to the windshield glass of a vehicle.

9. The MSC device according to claim 1, wherein a printed circuit (FR4) trace antenna, multi-layer ceramic chip antenna or PIFA antenna of a GPS receiver is glued on the windshield glass with a pig-tail coax cable connected to the GPS receiver module.

10. The MSC device according to claim 9, further the planar antenna of preferred ceramic chip antenna forming into the attachment part of a rearview mirror that sticks on the windshield glass, holds the GPS chip antenna for better reception of GPS signals.

11. The MSC device according to claim 1, wherein a contact or a contactless Smart Card reader device is embedded into the rearview/side mirror of a vehicle that serves as a second key for an anti-car-theft device.

12. The MSC device according to claim 2, wherein a contact or a contactless Smart Card reader device is embedded into a stand-alone unit that serves as a second key for an anti-car-theft device.

13. The MSC device according to claim 5, wherein the wireless communication module controlled by the central control that serve as a radio beacon for car theft alarm, emergency help beacon, receiving intemet data communication signals that includes but is not limited to data/voice/video information, earth- quake alarm, tornado alarm, enemy attack alarm and wireless broadband communication terminal to a PC, notebook PC or PDA.

14. The MSC device according to claim 1, wherein a Flash memory storage embedded into the rearview/side mirror of a vehicle in the form of Smart Media Card, Compact Flash Card, Secure Digital Card, Multi-Media Card or plan Flash memory IC soldered in the PCB of a MSC. Claims Page 36 of 41

15. The MSC device according to claim 1, wherein an Ethernet Communication Outlet is implanted in the rearview/side mirror of a vehicle.

16. The MSC device according to claim 2, wherein an Ethernet Communication Outlet is implanted in the stand-alone unit version of MSC device.

17. The MSC device according to claim 1, wherein both the USB host and USB device outlets is embedded in the rearview/side mounted mirror of a vehicle.

18. The MSC device according to claim 2, wherein both the USB host and USB device outlets is embedded into the stand-alone version of MSC device.

19. The MSC device according to claim 1, further with the USB/Ethernet outlet and the connection, between a MSC host to the mass storage Hard Disk for the commercial vehicle, records long periods of driving via the USB or an Ethernet interface.

20. The MSC device according to claim 1, wherein both the front-view and rearview wide-angle view lenses are embedded into the rearview/side mirror in a camouflaged method where the LED flash turns on when camera shuts during the night or dark moment.

21. The MSC device according to claim 19, wherein a multiplexer circuit that selects among plurality of CCD/CMOS lenses for digital camera compression module to reduce the redundancy of MPEG/JPEG compression circuit.

22. The MSC device according to claim 19, wherein the wide angle view of the lenses is equalized to compensate the driver's head and rearview which resides behind the rearview mirror where portions of the reflecting material is processed in a way such that the light reflects less for visual recording.

23. The MSC device according to claim 1, wherein the operation method of the MSC functions including:
a vehicle accident emergency alarm activation;
an anti-theft alarm activation;
a voice/motion recording scheme coordinated with the MSC motion sensor/gauge;
a digital video recording scheme coordinated with the MSC motion sensor/gauge;
an earthquake, tornado and enemy attack warning scheme;
a built-in Flash Memory of MSC downloaded to USB mobile driver to retrieve the video/voice/motion recording when an external USB mobile driver is plugged in to the MSC USB device outlet;
the transferring from DRAM to Flash memory when vehicle power off and built-in Lithium-ion battery kicked on;
MSC device works as a USB wireless communication adaptor when connected to a USB host such as a laptop PC for wireless communication;
MSC device works as a USB GPS receive adaptor when connected to a USB host such as a laptop PC for mapping and display;
MSC device as a USB voice communication adaptor when connected to a USB host such as a laptop PC;
MSC device as a USB digital camera adaptor when connected to a USB host such as a laptop PC;

24. The MSC device according to claim 1, wherein a double spring attached metal ball based acceleration/de-acceleration sensor/gauge for detecting and measuring the acceleration, de-acceleration, vibration and flip over conditions of a vehicle.

25. The MSC device according to claim 24, further comprising a micro-controller to identify significant instances to the central control module to coordinate the video/voice/motion recording and alarm/emergency activation. This micro-controller also takes the vehicle's speedometer input to consolidate with the motion gauge/sensor to record more complete vehicle motion data in the Flash memory.

26. The MSC device according to claim 1, wherein the USB interfaces for connecting between the central control to the multiple MSC peripheral modules comprising:
a wireless communication module with USB interface;
a voice communication and compression module with USB interface;
a multiple CCD/CMOS lenses with single JPEG/MPEG compression module with USB interface;
USB outlet to external MSC devices;

27. The MSC device according to claim 26, wherein the Central Control utilized a Samsung RISC CPU S3C2410X and GPS module utilized a ST Micro-electronics STB5610, ST20-GPS chip set and wireless communication module utilized a TI TNETW1100B and JPEG/MPEG compression utilized a DIVIO NW800 and voice communication module utilized TigerJet ST560 and USB hub controller utilized the ATMET AT43312 to compose the main electronic parts of MSC.
